(19) United States
(12) Patent Application Publication
(10) Pub. No.: US 2015/0095143 A1
(43) Pub. Date: Apr. 2, 2015

(54) SUBSCRIPTION SIGN-UP DEVICE

(71) Applicant: Verizon Patent and Licensing Inc., Basking Ridge, NJ (US)

(72) Inventors: Zhiying JIN, Lexington, MA (US); Shuai Wu, Waltham, MA (US)

(73) Assignee: Verizon Patent and Licensing Inc., Basking Ridge, NJ (US)

(21) Appl. No.: 14/042,070

(22) Filed: Sep. 30, 2013

(51) Int. Cl. G06Q 30/02

(52) U.S. Cl. CPC G06Q 30/0251
USPC 705/14.49

(57) ABSTRACT

A device is configured to receive customer information associated with a user at a kiosk device based on a user input to the kiosk device, and to determine status information based on the customer information. The status information may include information that identifies whether the user is eligible for a promotion. The device is configured to generate an account, associated with the user, based on the customer information and the status information. The device is configured to provide the status information to the kiosk device to cause the kiosk device to either provide the promotion or notify the user that the promotion is not available. The device is configured to provide a notification to the user based on the status information and based on the account.

### BACKGROUND

A service provider (e.g., an internet service provider, a cellular telephone service provider, etc.) may offer a service to users (e.g., a video streaming service, an audio streaming service, etc.). To access the service, the users may be associated with an account (e.g., an authentication system that authorizes the users to access the service).

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIGS. 4A-4B are flow charts of an example process for subscribing a user, associated with a kiosk device, to a subscription service;

FIGS. 5A-5C are diagrams of an example implementation relating to the example process shown in FIG. 4; and

FIGS. 6A-6B are diagrams of an example call flow relating to the example process shown in FIG. 4.

### DETAILED DESCRIPTION OF PREFERRED EMBODIMENTS

The following detailed description of example implementations refers to the accompanying drawings. The same reference numbers in different drawings may identify the same or similar elements.

A service provider (e.g., an internet service provider, a television provider, etc.) may advertise a service (e.g., a video streaming service) on a kiosk device. The advertisement may offer a promotion (e.g., a free gift) provided by the kiosk device in exchange for subscribing to the service. A user of the kiosk device may indicate a desire to subscribe to the service and receive the promotion (e.g., the free gift). A subscription device may generate an account associated with the user. Based on the account, the subscription device may determine whether the user qualifies for the promotion, and may notify the kiosk device of whether the promotion should be provided (e.g., whether the kiosk device should provide the free gift).

However, the user may have a limited amount of time to input information necessary to generate the account (e.g., due to other users waiting to access the kiosk device, due to an inefficient user interface associated with the kiosk device, due to a time constraint associated with the user, etc.). Implementations described herein may allow a subscription device to generate an account, associated with a user, based on a minimal amount of user input, and may permit the subscription device to cause a kiosk device to provide a promotion to the user based on generating the account.

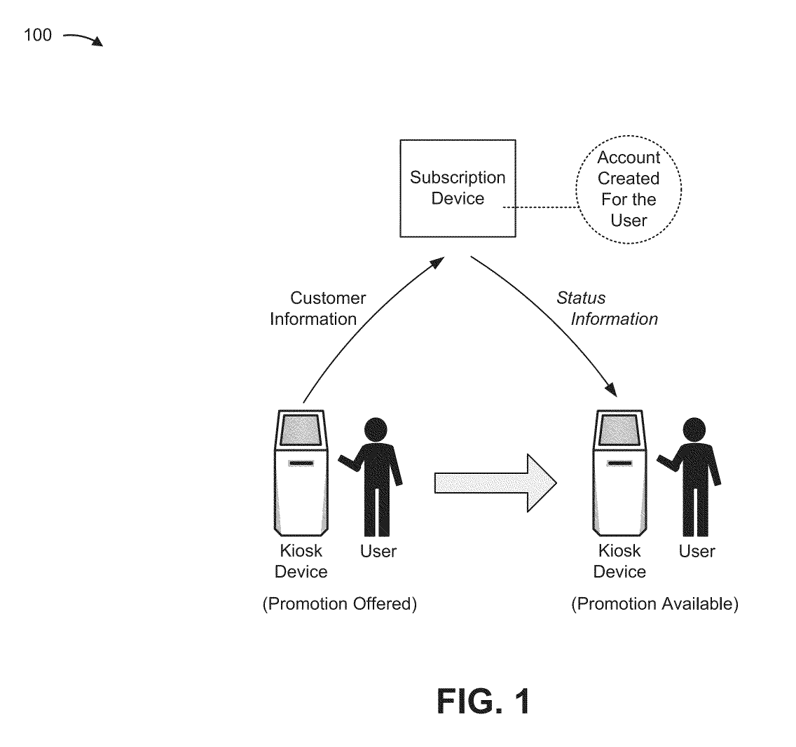

FIG. 1 is a diagram of an overview of an example implementation 100 described herein. As shown in FIG. 1, example implementation 100 may include a kiosk device, a user of the kiosk device, a subscription device.

As shown in FIG. 1, the kiosk device may receive user input indicating that the user would like to subscribe to a service in exchange for a promotion (e.g., a free gift provided by the kiosk device). The kiosk device may generate customer information associated with the user (e.g., based on information provided by the user, based on past interactions with the user, based on information associated with a kiosk account involving the user, based on billing information provided by the user, etc.). The kiosk device may provide the customer information to the subscription device.

As further shown in FIG. 1, the subscription device may generate an account associated with the user (e.g., a subscription account that permits the user access to a service offered by a service provider). Based on generating the account, the subscription device may determine status information associated with the account. The status information may indicate that the user qualifies for the promotion. The subscription system may provide the status information to the kiosk device. The kiosk device may provide the promotion (e.g., the free gift) based on receiving the status information. In this manner, the subscription device may subscribe the user to the service based on a minimal amount of user input, and may provide the promotion to the user based on the account.

Implementations described herein may allow a subscription device to generate an account, associated with a user, based on a minimal amount of user input, and may permit the subscription device to cause a kiosk device to provide a promotion to the user based on generating the account.

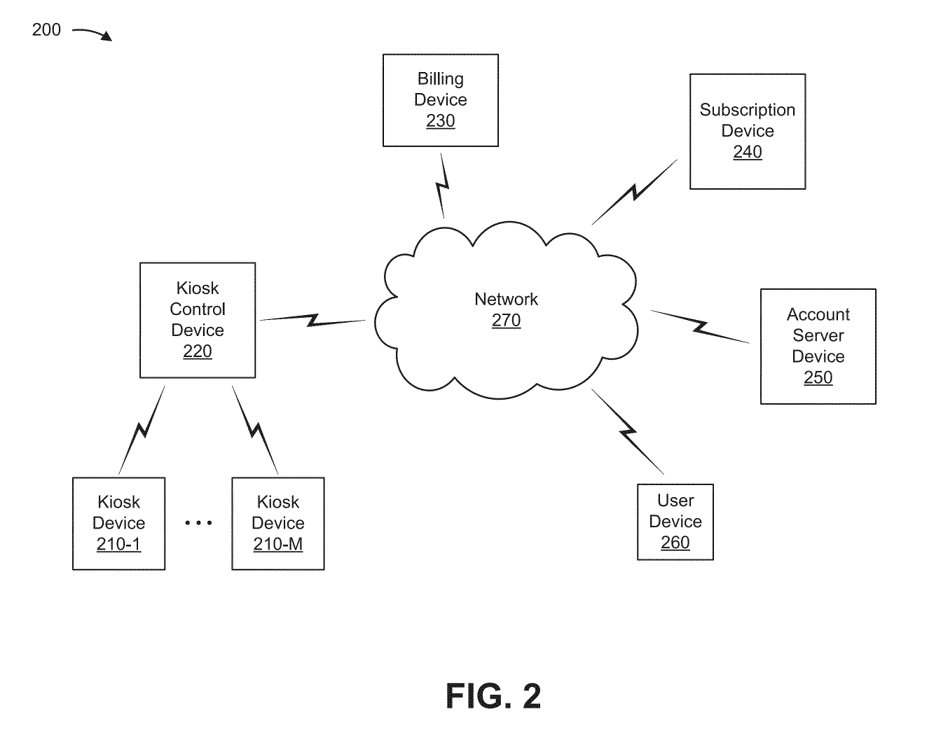

FIG. 2 is a diagram of an example environment 200 in which systems and/or methods described herein may be implemented. As shown in FIG. 2, environment 200 may include kiosk devices 210-1 . . . 210-M (M≧1) (hereinafter referred to collectively as “kiosk devices 210,” and individually as “kiosk device 210”), a kiosk control device 220, a billing device 230, a subscription device 240, an account server device 250, and a user device 260. Devices of environment 200 may interconnect via wired connections, wireless connections, or a combination of wired and wireless connections.

Kiosk device 210 may include a device capable of receiving, generating, processing, and/or providing information associated with the purchase and/or rental of an object or service. In some implementations, kiosk device 210 may include a mechanism (e.g., a display screen, a camera, a telephone, a keyboard, a keypad, a touchscreen, etc.) that may permit the user to provide user input. Kiosk device 210 may include an apparatus that may house one or more objects that are available for purchase and/or rent by a user (e.g., a purchaser, a renter, etc.), and may dispense the object to the user based on the user input. Additionally, or alternatively, kiosk device 210 may provide access to a service (e.g., a rental service, a subscription service, etc.). Kiosk device 210 may receive and/or send information associated with the purchase and/or rental from and/or to another device, such as kiosk control device 220. Additionally, or alternatively, kiosk device 210 may receive information from and/or transmit information to subscription device 240, account server device 250, and/or user device 260.

Kiosk control device 220 may include a device capable of receiving, processing, and/or providing information associated with a customer, such as customer information, billing information, or the like. For example, kiosk control device 220 may include a computer device (e.g., a desktop computer, a laptop computer, a table computer, a handheld computer, etc.), a server, or a similar device. In some implementations, kiosk control device 220 may provide the information associated with the customer to subscription device 240, and may receive information from subscription device 240 (e.g., information about a subscription associated with the customer). Additionally, or alternatively, kiosk control device 220 may receive information from and/or transmit information to kiosk device 210, account server device 250, and/or user device 260.

Billing device 230 may include a device capable of receiving, processing, and/or providing billing information (e.g., payment card information, bank account information, etc.). For example, billing device 230 may include a computer device (e.g., a desktop computer, a laptop computer, a table computer, a handheld computer, etc.), a server, or a similar device. In some implementations, billing device 230 may receive information from and/or transmit information to kiosk device 210, kiosk control device 220, subscription device 240, account server device 250, and/or user device 260.

Subscription device 240 may include a device capable of generating a subscription associated with a user and/or providing information associated with the subscription to one or more devices (e.g., kiosk control device 220, account server device 250, user device 260, etc.). For example, subscription device 240 may include a computer device (e.g., a desktop computer, a laptop computer, a table computer, a handheld computer, etc.), a server, or a similar device. In some implementations, subscription device 240 may receive information from and/or transmit information to kiosk device 210, kiosk control device 220, account server device 250, and/or user device 260.

Account server device 250 may include one or more devices capable of receiving, storing, processing, and/or transmitting information, such as information associated with a subscription. For example, account server device 250 may include a computing device, such as a server, a desktop computer, a laptop computer, a tablet computer, a handheld computer, or a similar device. In some implementations, account server device 250 may receive information from and/or transmit information to kiosk device 210, kiosk control device 220, subscription device 240, and/or user device 260.

User device 260 may include a device capable of receiving, storing, generating, and or sending notifications (e.g., email notifications, short message service (SMS) text message notifications, etc.). For example, user device 260 may include a landline telephone, a mobile telephone (e.g., a smartphone, a radiotelephone, etc.), a computing device (e.g., a desktop computer, a laptop computer, a tablet computer, a handheld computer, etc.), or a similar device. In some implementations, user device 260 may receive information from and/or transmit information to kiosk device 210, kiosk control device 220, subscription device 240, and/or account server device 250.

Network 270 may include one or more wired and/or wireless networks. For example, network 270 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, or a combination of these or other types of networks.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

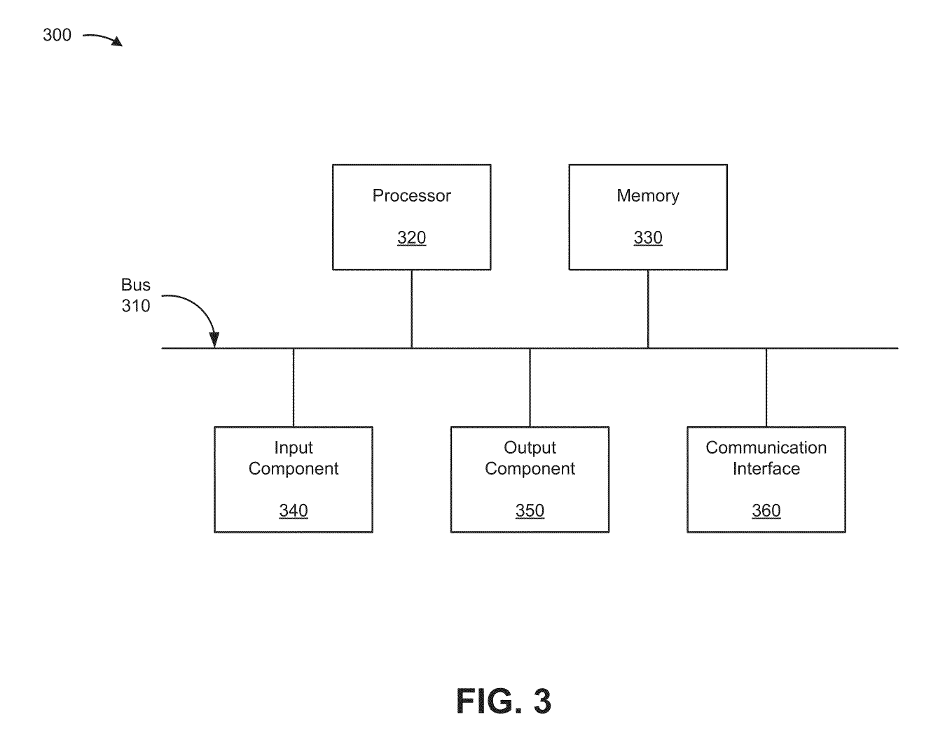

FIG. 3 is a diagram of example components of a device 300. Device 300 may correspond to kiosk device 210, kiosk control device 220, billing device 230, subscription device 240, account server device 250, and/or user device 260. Additionally, or alternatively, each of kiosk device 210, kiosk control device 220, billing device 230, subscription device 240, account server device 250, and/or user device 260 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing component (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

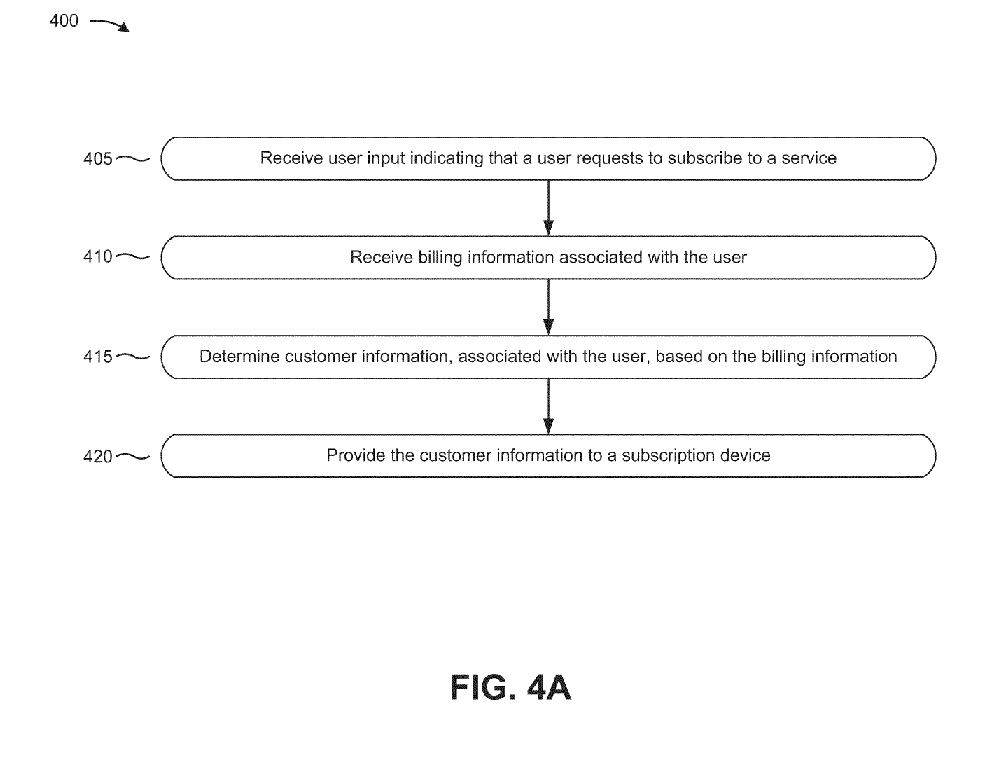

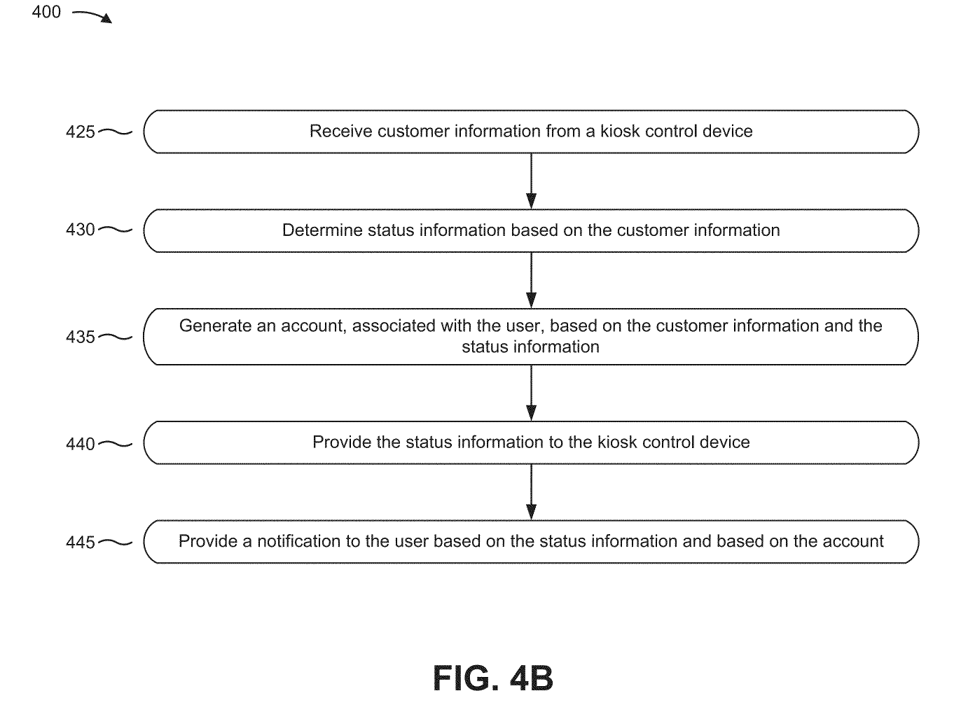

FIGS. 4A-4B is a flow chart of an example process 400 for subscribing a user, associated with a kiosk device, to a subscription service. In some implementations, one or more process blocks of FIG. 4A may be performed by kiosk control device 220. In some implementations, one or more process blocks of FIG. 4B may be performed by subscription device 240. Additionally, or alternatively, one or more process blocks of FIGS. 4A-4B may be performed by another device or a group of devices separate from or including kiosk control device 220 and/or subscription device 240, such as kiosk device 210, billing device 230, account server device 250, and/or user device 260.

As shown in FIG. 4A, process 400 may include receiving user input indicating that a user requests to subscribe to a service (block 405). For example, the user may provide user input to kiosk device 210 via a user interface (e.g., a touchscreen display, a keypad, a keyboard, a mouse, a camera, a microphone, a motion sensor, etc.). The user input may indicate that the user requests to subscribe to the service. Based on receiving the user input, kiosk device 210 may provide the user input to kiosk control device 220. Additionally, or alternatively, kiosk control device 220 may receive the user input from the user (e.g., via a user interface associated with kiosk control device 220).

In some implementations, kiosk control device 220 may receive the user input based on an advertisement. For example, kiosk control device 220 may provide the advertisement to kiosk device 210. Kiosk device 210 may display the advertisement via a user interface associated with kiosk device 210. Based on the advertisement, the user may provide user input, via the user interface, indicating that the user would like to subscribe to the service. Kiosk device 210 may provide the user input to kiosk control device 220. In some implementations, kiosk device 210 may display the advertisement based on a prior interaction with the user (e.g., based on a prior user input, based on a prior use of a credit card by the user, etc.).

In some implementations, the advertisement may include an invitation for the user to receive a service (e.g., a subscription service). In some implementations, the advertisement may include an incentive program. For example, the incentive program may offer a gift (e.g., a free object, a discounted object, a gift certificate, a rebate, a coupon, a free rental, a free trial, etc.) if the user chooses to subscribe to the service. In some implementations, the gift may include an object associated with kiosk device 210 (e.g., an object offered for sale and/or rent by kiosk device 210).

In some implementations, the incentive program may offer a set of gifts based on a length of the subscription. For example, the incentive program may offer a periodic gift (e.g., a daily coupon, a weekly rental, a monthly rebate, etc.) for a period of time associated with the subscription (e.g., for the duration of the subscription, for a first 3 months of the subscription, etc.).

In some implementations, kiosk control device 220 may determine the gift based on a user history. The user history may include prior user input associated with the user. For example, the prior user history may include information that identifies the user's prior purchases, prior rentals, prior selections, or the like. Based on the prior user history, kiosk control device 220 may determine the gift (e.g., may determine a gift that is similar to prior purchases and/or prior rentals). Kiosk control device 220 may provide information that identifies the gift to kiosk device 210 (e.g., for display on kiosk device 210).

In some implementations, kiosk device 210 may offer objects for rent (e.g., DVDs, CDs, etc.). Additionally, or alternatively, kiosk device 210 may offer access to music, audiobooks, or the like. The advertisement may advertise a free rental (e.g., a free DVD or CD rental) if the user subscribes to a service (e.g., a video streaming service, an audio streaming service, etc.). Based on the advertisement, kiosk device 210 may receive user input indicating that the user requests to subscribe to the service. Kiosk device 210 may provide the user input to kiosk control device 220.

As further shown in FIG. 4A, process 400 may include receiving billing information associated with the user (block 410). For example, the user may provide the billing information to kiosk device 210 (e.g., via user input), and kiosk device 210 may provide the billing information to kiosk control device 220. Additionally, or alternatively, kiosk control device 220 may receive the user input from the user (e.g., via a user interface associated with kiosk control device 220).

In some implementations, the billing information may include information that identifies how the user cab pay for a good and/or a service. For example, the billing information may include a quantity of money to be billed, a financial account to be billed (e.g., a bank account, a credit account, etc.), an address associated with the payer (e.g., a user address), a name associated with the payer (e.g., a user name), or the like.

In some implementations, the billing information may be associated with a payment card (e.g., a credit card, a debit card, a gift card, etc.). In this instance, the billing information may include a payment card number (e.g., a credit card number, a debit card number, a gift card number, etc.), a name associated with the payment card (e.g., a cardholder name), an address associated with the payment card (e.g., a cardholder address), or the like. In some implementations, kiosk device 210 and/or kiosk control device 220 may be associated with a card reader (e.g., a payment card reader), and may receive the billing information based on detecting the payment card with the card reader (e.g., based on the payment card being swiped through the card reader by the user). Additionally, or alternatively, kiosk device 210 may receive the billing information based on user input from the user (e.g., via a user interface associated with kiosk device 210). In some implementations, kiosk device 210 may display the billing information (e.g., a billing address, a billing name, etc.), and may receive a confirmation (e.g., via user input) that the billing information is correct.

In some implementations, kiosk device 210 and/or kiosk control device 220 may verify the billing information (e.g., determine whether the billing information permits kiosk device 210 and/or kiosk control device 220 to complete a sale and/or rental associated with the user). For example, kiosk device 210 and/or kiosk control device 220 may verify the billing information by use of a payment card service (e.g., a credit card service, a debit card service, a bank, etc.) to verify that the billing information is correct (e.g., that the payment card is valid, that funds associated with the payment card are sufficient, etc.).

In some implementations, the kiosk device 210 and/or kiosk control device 220 may determine a reason why the billing information is not valid. For example, kiosk device 210 and/or kiosk control device 220 may determine that a financial account identified by the billing information is associated with insufficient funds, that a payment card number identified by the billing information is not associated with a valid financial account, that a payment card identified by the billing information is expired, that a cardholder name identified by the billing information does not match a user name (e.g., a name provided by the user), that an address identified by the billing information (e.g., an address associated with the payment card) does not match an address associated with the user, or the like.

In some implementations, kiosk device 210 and/or kiosk control device 220 may determine a payment identifier associated with the billing information. The payment identifier may include a set of characters (e.g., numbers, letters, symbols, etc.) that uniquely identifies billing information associated with a user. In some implementations, the payment identifier may permit another device (e.g., subscription device 240) to charge a payment to the customer without the use of the billing information (e.g., by use of the payment identifier). For example, kiosk control device 220 may provide the billing information and the payment identifier to billing device 230. Billing device 230 may store an association, between the billing information and the payment identifier, in a data structure associated with billing device 230. Subscription device 240 may send a notification (e.g., including the payment identifier) indicating that the user is to be billed. Based on the payment identifier and associated billing information, billing device 230 may bill the user.

As further shown in FIG. 4A, process 400 may include determining customer information, associated with the user, based on the billing information (block 415). In some implementations, the customer information may include information associated with a user (e.g., a user of kiosk device 210). For example, the customer information may include a name associated with the user, an address associated with the user, telephone number associated with the user (e.g., a cellular telephone number), an email address associated with the user, or the like. In some implementations, kiosk control device 220 may determine the customer information based on the billing information (e.g., the billing information received from kiosk device 210). For example, kiosk control device 220 may determine the customer information based on a name associated with the payment card, an address associated with the payment card, or the like.

In some implementations, kiosk control device 220 may determine the customer information based on a kiosk account associated with the user. The kiosk account may include an account that permits the user to purchase goods and/or services from kiosk devices 210. Kiosk control device 220 may determine the customer information based on information associated with the kiosk account. In some implementations, kiosk control device 220 may generate a kiosk account associated with the user (e.g., based on determining that the user is not already associated with the kiosk account). Additionally, or alternatively, kiosk control device 220 may determine a kiosk customer identifier associated with the user and/or the kiosk account.

In some implementations, the customer information may include user preference information. The user preference information may include information that identifies one or more preferences associated with the user (e.g., associated with the kiosk account). For example, the user preference information may include past purchases by the user, products and/or services preferred by the user, or the like. In some implementations, kiosk device 210 may be associated with DVD rentals, and the user preference information may identify one or more media genres preferred by the user (e.g., movie genres, television genres, video game genres, etc.), past rentals (e.g., prior DVDs rented by the user), or the like. Additionally, or alternatively, kiosk device 210 may be associated with CD rentals, and the user preference information may identify one or more media genres preferred by the user (e.g., music genres, audiobook genres, etc.), past rentals (e.g., prior CDs rented by the user), or the like.

In some implementations, kiosk device 210 and/or kiosk control device 220 may receive a confirmation that the customer information is correct. For example, kiosk device 210 and/or kiosk control device 220 may provide the customer information to the user (e.g., via a user interface), and may request that the user verify the customer information. The user may provide user input indicating that customer information is correct (e.g., a confirmation). Additionally, or alternatively, the user may provide user input indicating that the customer information is incorrect. In this instance, the user may provide corrected customer information via the user interface.

In some implementations, the customer information may include the billing information, including the payment identifier. Additionally, or alternatively, the customer information may include information indicating that the billing information is valid (e.g., that the user is associated with a valid payment card, a valid bank account, etc.). In some implementations, the customer information may include information indicating that the billing information is not valid, and may include information that identifies why the billing information is not valid (e.g., that the payment card has expired, that an address associated with the payment card does not match an address provided by the user, etc.).

In some implementations, kiosk device 210 and/or kiosk control device 220 may determine a subscription customer identifier associated with the user. The subscription customer identifier may include a set of characters (e.g., numbers, letters, symbols, etc.) that uniquely identify the user. In some implementations, kiosk control device 220 may store an association, between the customer information and the customer identifier, in a data structure associated with kiosk control device 220. Additionally, or alternatively, kiosk control device 220 may store an associated between the subscription customer identifier and the kiosk customer identifier.

As further shown in FIG. 4A, process 400 may include providing the customer information to a subscription device (block 420). For example, kiosk control device 220 may provide the customer information to subscription device 240. In some implementations, kiosk control device 220 may provide the customer information via a message (e.g., an email message, an SMS text message, etc.), a document, a file (e.g., a computer file), or the like.

In some implementations, kiosk control device 220 may provide a portion of the customer information to subscription device 240. For example, kiosk control device 220 may provide the payment identifier to subscription device 240, and may not provide the billing information associated with the payment identifier (e.g., payment card information). In this manner, kiosk control device 220 may permit subscription device 240 to bill the user (e.g., via the payment identifier) without receiving the billing information.

In some implementations, kiosk control device 220 may determine a set of customer information associated with a set of users (e.g., associated with kiosk devices 210). Kiosk control device 220 may queue the set of customer information for delivery to subscription device 240. In some implementations, kiosk control device 220 may provide the customer information in the queue one at a time (e.g., may send customer information associated with a first user followed by customer information associated with a second user followed by customer information associated with a third user and so forth). Additionally, or alternatively, kiosk control device 220 may provide the customer information in the queue in batches (e.g., associated with groups of users).

As shown in FIG. 4B, process 400 may include receiving customer information from a kiosk control device (block 425). For example, subscription device 240 may receive the customer information from kiosk control device 220. In some implementations, subscription device 240 may receive a subscription customer identifier associated with the customer information. Based on the subscription customer identifier, subscription device 240 may request additional customer information from kiosk control device 220. Based on the association between the subscription customer identifier and a kiosk customer identifier, kiosk control device 220 may provide the customer information to subscription device 240 (e.g., customer information associated with a kiosk account of the user).

As further shown in FIG. 4B, process 400 may include determining status information based on the customer information (block 430). In some implementations, the status information may include information that identifies a status of the account. For example, the status information may identify whether the account is active, suspended, abandoned, or the like. Additionally, or alternatively, the status information may identify whether the account is new (e.g., associated with a user who is not previously associated with the service) or old (e.g., associated with a user who has already used the service).

In some implementations, the status information may include information that identifies whether the billing information associated with the user is valid. For example, the status information may identify whether the billing information may permit subscription device 240 to bill the user for the service. In some implementations, if the billing information is not valid, the status information may identify a reason the billing information is not valid (e.g., that an address provided by the user does not match an address associated with a payment card, that the payment card is expired, etc.).

In some implementations, the status information may include information that identifies whether the user qualifies for a promotion. For example, the status information may identify whether the user qualifies for a gift (e.g., a gift associated with an incentive program provided to the user by kiosk device 210). In some implementations, subscription device 240 may determine that the user qualifies for the promotion based on determining that the account associated with the user is active. For example, based on determining that the user is new to the service, and is associated with valid billing information, subscription device 240 may determine that the account is active and that the user qualifies for the promotion.

In some implementations, subscription device 240 may determine that the user does not qualify for the promotion. For example, subscription device 240 may determine that the user does not qualify for the promotion based on determining that the user is not associated with valid billing information, is not a new customer (e.g., already has an account associated with the service), has already participated in the promotion, or the like.

As further shown in FIG. 4B, process 400 may include generating an account, associated with a user, based on the customer information and the status information (block 435). For example, subscription device 240 may determine the account, and may provide information associated with the account (e.g., account information) to account server device 250.

In some implementations, the account may permit the user to access a good and/or a service. For example, the account may permit the user to gain access to an internet site, a computer program, a computer file, or the like. In some implementations, the account may permit the user to access a media streaming service (e.g., a movie streaming service, a music streaming service, an audiobook streaming service, etc.).

In some implementations, subscription device 240 may generate the account by storing an association between the account and the user. For example, subscription device 240 may store an association between the customer identifier and the account. In some implementations, subscription device 240 may store the association between the account and the user in a data structure (e.g., associated with subscription device 240, account server device 250, etc.).

In some implementations, subscription device 240 may determine information needed to access the account (e.g., login information). For example, subscription device 240 may generate a username associated with the account, a password associated with the account, an identifier associated with the account, or the like. In some implementations, subscription device 240 may generate a temporary password (e.g., a password to be used temporarily until a user may determine a permanent password). For example, subscription device 240 may generate a temporary password that may later expire (e.g., after a specified period of time, after a specified number of logins, etc.).

In some implementations, subscription device 240 may determine subscription pricing associated with the account. The subscription pricing may include an amount to be charged to the user for access to the goods and/or services associated with the account. In some implementations, subscription device 240 may receive the subscription pricing from account server device 250.

In some implementations, the account may be associated with information that identifies one or more preferences associated with the user (e.g., preferences identified by the customer information). Additionally, or alternatively, the account may be associated with another account related with the user (e.g., a cellular telephone service account, an internet service account, a television service account, etc.). For example, subscription device 220 may determine that the user is associated with an internet service provider account. Subscription device 220 may receive information associated with the internet service provider account from account server 250 (e.g., contact information associated with the internet service provider account, billing information associated with the internet service provider account, etc.).

As further shown in FIG. 4B, process 400 may include providing the status information to the kiosk control device (block 440). For example, subscription device 240 may provide the status information to kiosk control device 220. In some implementations, kiosk control device 220 may provide the status information to kiosk device 210.

In some implementations, subscription device 240 may provide the status information to kiosk control device 220 to cause kiosk control device 220 and/or kiosk device 210 to provide a promotion. For example, subscription device 240 may provide the status information to kiosk control device 220 indicating that the customer qualifies for the promotion (e.g., that the customer is a new customer, that the customer is associated with valid billing information, etc.). Based on the status information, kiosk control device 220 may provide a notification to kiosk device 210 to cause kiosk device 210 to provide the promotion to the customer (e.g., to permit the customer to receive the gift associated with the promotion). In some implementations, the promotion may include a free DVD rental, and subscription device 240 may provide status information to kiosk control device 220 indicating that the customer qualifies for the free DVD rental.

In some implementations, subscription device 240 may provide the status information to kiosk control device 220 to cause kiosk control device 220 and/or kiosk device 210 to notify the user of a status of the account. For example, subscription device 240 may provide the status information to kiosk control device 220 indicating that subscription device 240 has generated a valid account associated with the user. Based on the status information, kiosk control device 220 may cause kiosk device 210 to notify the user as to the status of the account (e.g., to display a notification indicating that a valid account has been created). Additionally, or alternatively, kiosk device 210 may provide information associated with the account (e.g., an account identifier, a username, a password, etc.) to the user via a user interface associated with kiosk device 210.

In some implementations, the status information may indicate that the account is not active (e.g., that the billing information is not valid, that the user is already associated with an account, etc.). Based on the status information, kiosk control device 220 may cause kiosk device 210 to notify the user that a valid account could not be created. In some implementations, based on the status information, kiosk device 210 may notify the user that a promotion is unavailable. Additionally, or alternatively, kiosk device 210 may provide information identifying a reason that the promotion is unavailable (e.g., indicating that the billing information is invalid, that the user is already associated with an account, etc.).

In some implementations, subscription device 240 may provide the status information to billing device 230 to cause billing device 230 to bill the user. For example, subscription device 240 may provide status information to billing device 230 indicating that a user is to be billed, and may provide the payment identifier. Based on the status information and the payment identifier, billing device 230 may bill the user (e.g., using the billing information associated with the payment identifier).

As further shown in FIG. 4B, process 400 may include providing a notification to the user based on the status information and based on the account (block 445). For example, subscription device 240 may provide a notification to user device 260.

In some implementations, the notification may include a message (e.g., an email, an SMS text message, an electronic document, an image, a video, etc.). In some implementations, subscription device 240 may provide the notification by sending the message to user device 260 (e.g., via a telephone number), to an email account associated with the user (e.g., via an email address), to a computing device associated with the user (e.g., via an internet protocol (IP) address), or the like.

In some implementations, the notification may include information associated with the account. For example, the notification may include an account identifier, a username, a password (e.g., a temporary password, a permanent password, etc.), or the like. Additionally, or alternatively, the notification may include a payment schedule associated with the account (e.g., amounts and/or due dates of payments associated with the account), contract terms associated with the account, services associated with the account, or the like.

In some implementations, the notification may include information that identifies a status associated with the account (e.g., whether the account is active, suspended, etc.). Additionally, or alternatively, the notification may include information for remedying an error associated with the account. For example, the notification may include information that identifies how the user may provide valid billing information, update customer information associated with the account, or the like.

In some implementations, the notification may include information for obtaining an application (e.g., application software) associated with a service (e.g., a service associated with the account). For example, the notification may include information (e.g., a hyperlink, a web address, etc.) that identifies an application that may be downloaded by user device 260. In some implementations, the service may include a video streaming service, and the application may include an application for streaming videos on a mobile device (e.g., a smartphone, a computer tablet, etc.).

In some implementations, subscription device 240 may provide the information for obtaining the application based on a device type associated with the user (e.g., based on determining that the user is associated with a smartphone, a tablet computer, etc.). For example, subscription device 240 may determine the device type based on the customer information (e.g., based on information provided by the user that identifies the device type).

In some implementations, based on the notification, the user may access the service associated with the account. For example, the user may use the username and password associated with the notification to log into the service (e.g., via user device 260). Additionally, or alternatively, the user may log into the service to view purchases, view a history of prior interactions with the service, update customer information, change billing information, or the like.

Although FIGS. 4A-4B show example blocks of process 400, in some implementations, process 400 may include additional blocks, fewer blocks, different blocks, and/or differently arranged blocks than those depicted in FIGS. 4A-4B. Additionally, or alternatively, two or more of the blocks of process 400 may be performed in parallel.

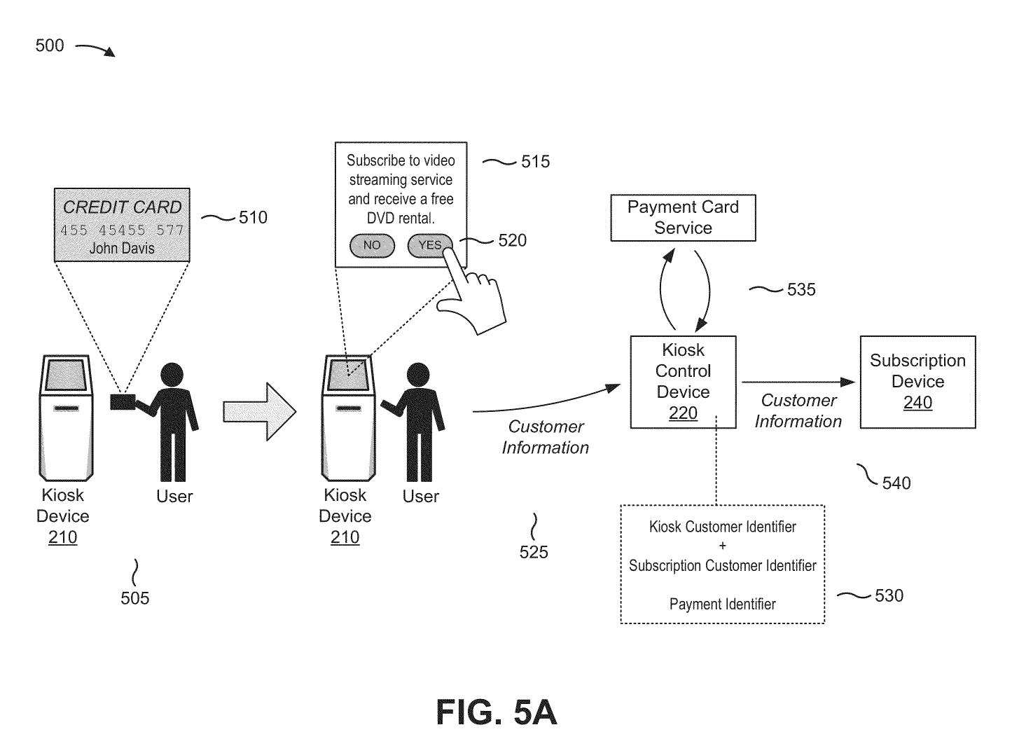

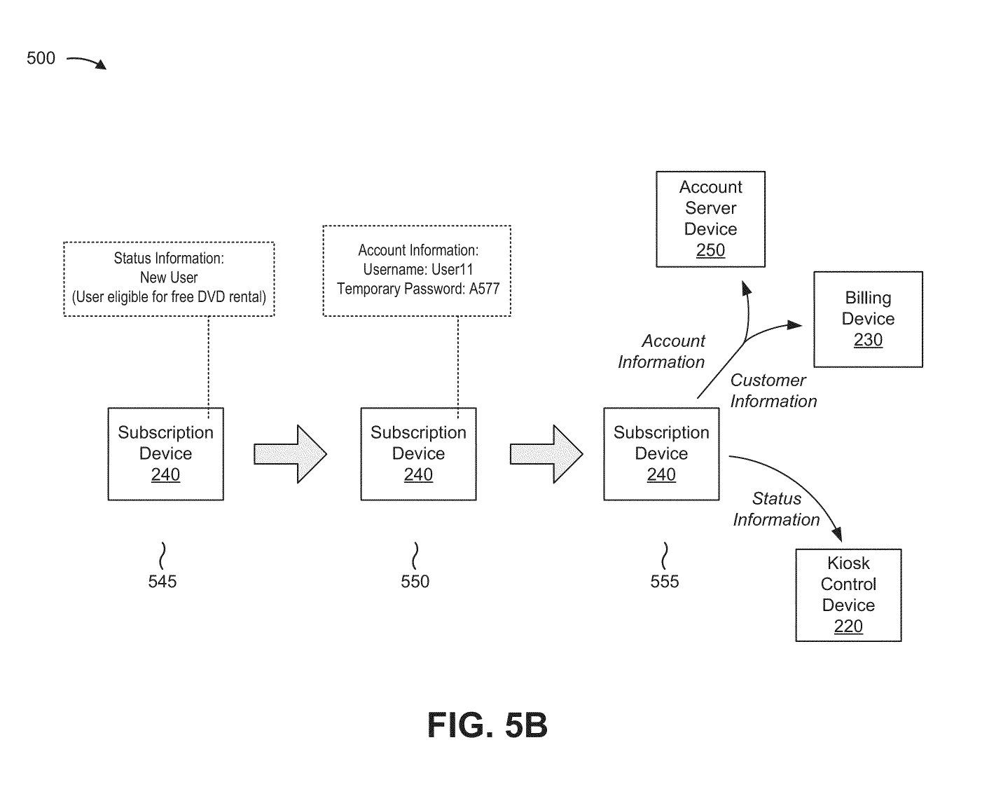

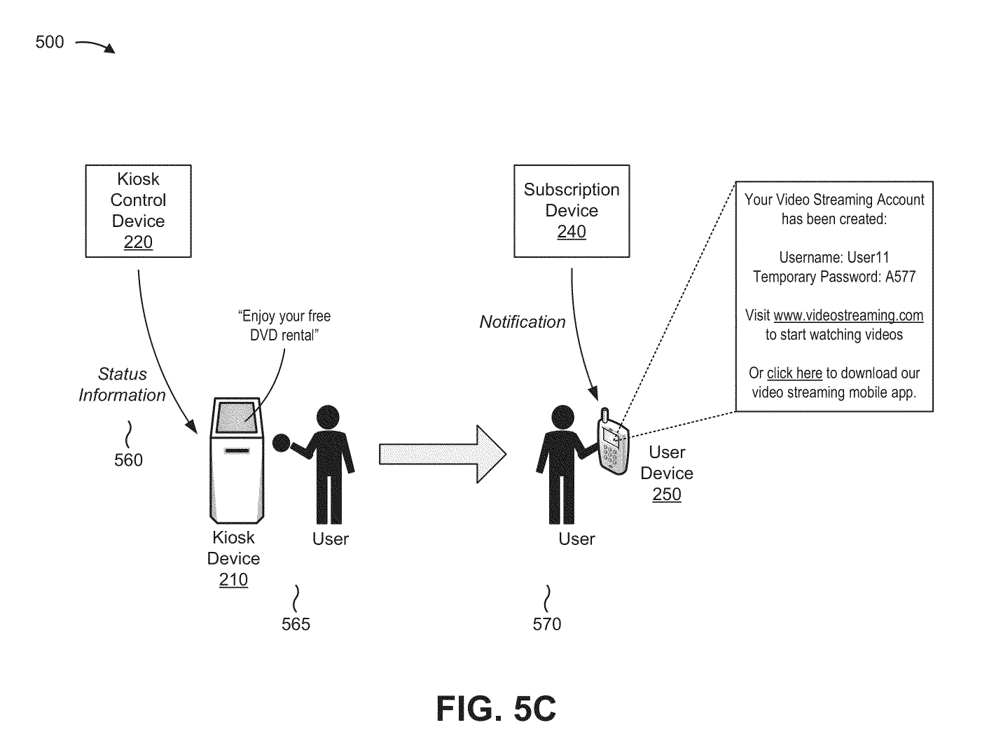

FIGS. 5A-5C are diagrams of an example implementation 500 relating to process 400 (FIG. 4). In example implementation 500, a user may visit kiosk device 210, and may respond to an offer to subscribe to a video streaming service. Based on customer information associated with the user, subscription device 240 may create an account to permit the user to access the video streaming service.

As shown by reference number 505, a user may visit kiosk device 210 to rent a DVD. As shown by reference number 510, the user may swipe a credit card to access a kiosk account associated with the customer and to pay for the DVD rental. Based on the credit card, kiosk device 210 may determine customer information, including information that identifies a name (e.g., “John Davis”) associated with the user, an address associated with the user, a credit card number (e.g., “455 45455 577”), or the like.

As shown by reference number 515, kiosk device 210 may display a promotion offering a free DVD rental if the user subscribes to the video streaming service. The user may respond affirmatively to the promotion by touching a region of a touchscreen display, associated with kiosk device 210, which corresponds to a button, as shown by reference number 520.

As shown by reference number 525, kiosk device 210 may provide the customer information to kiosk control device 220. As shown by reference number 530, kiosk control device 220 may generate a kiosk customer identifier (e.g., for use by kiosk control device 220) and a subscription customer identifier (e.g., for use by subscription device 240) associated with the user, and may store the association between the kiosk customer identifier and the subscription customer identifier (e.g., in a data structure associated with kiosk control device 220). Additionally, kiosk control device 220 may generate a payment identifier associated with the billing information (e.g., the credit card), and may store the association between the payment identifier and the billing information (e.g., in a data structure associated with kiosk control device 220). Kiosk control device 220 may verify that the billing information is correct (e.g., that the credit card is valid) by sending a query to a payment card service and receiving a reply, as shown by reference number 535.

As shown by reference number 540, kiosk control device 220 may provide a portion of the customer information to subscription device 240. Kiosk control device 220 may provide the name of the user, the address of the user, the subscription customer identifier, and the payment identifier. Additionally, kiosk control device 220 may provide information associated with the kiosk account (e.g., information stored in a data structure associated with kiosk control device 220), including an email address associated with the user, a telephone number associated with the user, or the like.

As shown in FIG. 5B, and by reference number 545, subscription device 240 may determine a status associated with the user. Subscription device 240 may determine that the user is a new user (e.g., that the user is not already associated with an existing account, that the user does not already have access to the video streaming service, etc.), and that the user is eligible for a free DVD rental (e.g., that the user has not already received a promotion).

As shown by reference number 550, subscription device 240 may generate an account associated with user based on the status of the user (e.g., based on determining that the user is a new user). Subscription device 240 may generate a username (e.g., “User11”) and a temporary password (e.g., “A577”). As shown by reference number 555, subscription device 240 may provide the customer information and the account information to account server device 250 and billing device 230. Subscription device 240 may provide the status information (e.g., that the user is eligible for a free DVD rental) to kiosk control device 220.

As shown in FIG. 5C, and by reference number 560, kiosk control device 220 may provide the status information to kiosk device 210. As shown by reference 565, based on the status information, kiosk device 210 may display a notification indicating that the user may use the promotion (e.g., “Enjoy your free DVD rental”). The user may elect to use the promotion at that time.

As shown by reference number 570, subscription device 240 may send an email to user device 260 (e.g., based on the email address identified by the customer information). As shown by reference number 575, the email may include the username (e.g., “User11”), the temporary password (e.g., “A577”), a hyperlink to access the video streaming service (e.g., “www.videostreaming.com”), and an option to download a mobile application.

As indicated above, FIGS. 5A-5C are provided merely as an example. Other examples are possible and may differ from what was described with regard to FIGS. 5A-5C.

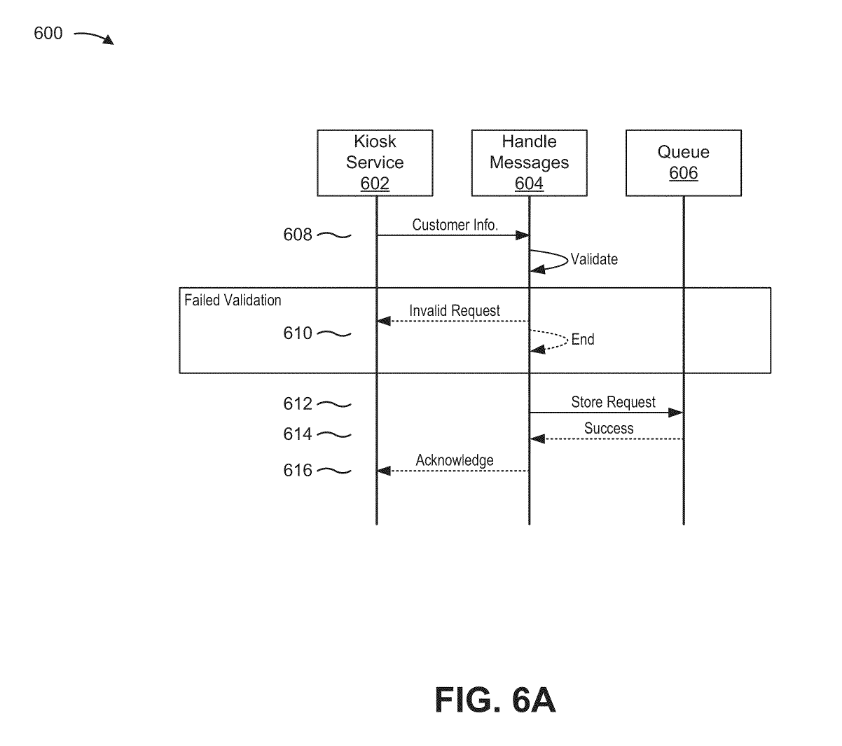

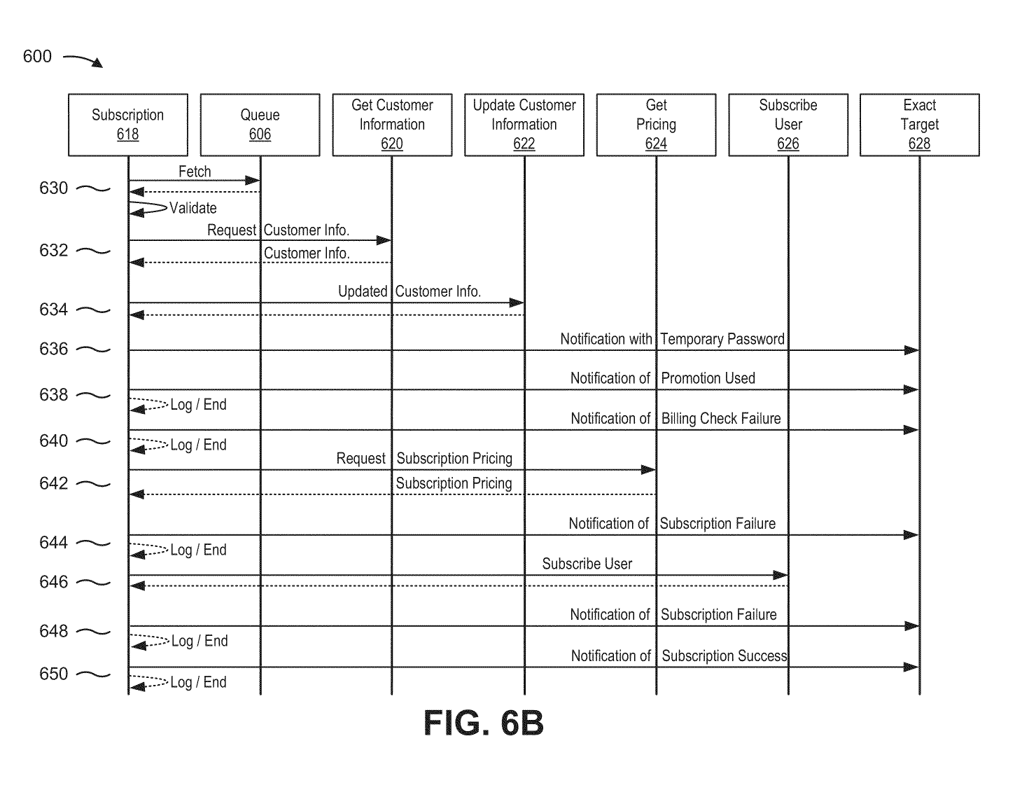

FIGS. 6A-6B are diagrams of an example call flow 600 for determining a subscription account associated with a user at a kiosk device. In FIGS. 6A-6B, kiosk device 210, kiosk control device 220, subscription device 240, account server device 250, and/or user device 260 may receive, process, and/or transmit calls by use of one more application programming interfaces (“APIs”) that permit one or more applications (e.g., associated with one or more devices of environment 200) to communicate. In some implementations, kiosk device 210, kiosk control device 220, billing device 230, subscription device 240, account server device 250, and/or user device 260 may use session initiation protocol (“SIP”) to create, modify, and/or terminate two party and/or multiparty communication sessions (e.g., telephone calls, video conferencing, multimedia streaming, etc.).

As shown in FIG. 6A, call flow 600 may include a kiosk service API 602, a handle messages API 604, and a queue API 606. In some implementations, kiosk service API 602, handle messages API 604, and/or queue API 606 may be associated with kiosk device 210, kiosk control device 220, billing device 230, subscription device 240, account server device 250, and/or user device 260.

As shown by reference number 608, kiosk service API 602 (e.g., subscription device 240) may receive an indication that a user (e.g., associated kiosk device 210 and/or kiosk control device 220) is to be associated with an account, and may receive a kiosk customer identifier and a subscription customer identifier associated with the user. Kiosk service API 602 may provide the kiosk customer identifier and the subscription customer identifier, via a call, to handle messages API 604. Handle messages API 604 may validate the kiosk customer identifier and the subscription customer identifier.

As shown by reference number 610, if handle messages API 604 determines that the kiosk customer identifier and/or the subscription customer identifier is invalid, handle messages API 604 may notify kiosk service API 610, via a call, that the request is invalid. Handle messages API 604 may end the queuing process.

As shown by reference number 612, if handle messages API 604 determines that the kiosk customer identifier and the subscription customer identifier are valid, handle messages API 604 may provide the kiosk customer identifier and the subscription customer identifier to queue API 608 via a call. Queue API 608 may store the kiosk customer number in a data structure (e.g., associated with subscription device 240, account server device 250, etc.) as a queue of customer information (e.g., along with other kiosk customer identifiers and/or other subscription customer identifiers associated with other users of kiosk devices 210). As shown by reference number 614, queue API 606 may notify handle messages API 604, via a call, that the kiosk customer identifier and the subscription customer identifier were successfully stored. Handle messages API 604 may provide an acknowledgement to kiosk service API 602, as shown by reference number 616.

As shown in FIG. 6B, along with queue API 604, call flow 600 may include a subscription API 618, a get customer information API 620, an update customer information API 622, a get pricing API 624, a subscribe user API 626, and an exact target API 628. In some implementations, subscription API 618, get customer information API 620, update customer information API 622, get pricing API 624, subscribe user API 626, and/or exact target API 628 may be associated with kiosk device 210, kiosk control device 220, subscription device 240, account server device 250, user device 260, and/or another device or group of devices.

As shown by reference number 630, subscription API 618 may call queue API 606 to request a kiosk customer identifier and a subscription customer identifier. Queue API 606 may provide the kiosk customer identifier and the subscription customer identifier to subscription API 618, and subscription API 618 may validate the kiosk customer identifier and the subscription customer identifier.

As shown by reference number 632, based on validating the kiosk customer identifier and the subscription customer identifier, subscription API 614 may call get customer information API 620 to request customer information associated with the subscription customer identifier. Based on an association between the subscription customer identifier and a kiosk customer identifier (e.g., associated with kiosk device 210 and/or kiosk control device 220), get customer information API 620 may access the customer information (e.g., stored in a data structure associated with kiosk device 210 and/or kiosk control device 220), and may provide the customer information to subscription API 618. The customer information may include contact information associated with the user (e.g., a name, an address, a telephone number, an email address, etc.), billing information (e.g., a payment identifier), user preferences, or the like.

As shown by reference number 634, subscription API 618 may call update customer information API 622 to provide the customer information (e.g., to account server device 250 to cause account server device 250 to store the customer information in a data structure associated with account server device 250).

As shown by reference number 636, subscription API 618 may determine whether the user is a new user. If the user is a new user, subscription API 618 may generate a temporary password, and may call exact target API 628 to provide the temporary password. Exact target API 628 may send a notification (e.g., an email, an SMS text message, etc.), including the temporary password, to user device 260 (e.g., by use of an email address identified by the customer information, a telephone number identified by the customer information, etc.).

As shown by reference number 638, subscription API 618 may determine whether the user has already received a promotion (e.g., has already used a free trial offered via kiosk device 210). If the user has already used the promotion, subscription API 618 may notify exact target API 628, via a call, that the promotion is not available to the user. Exact target API 628 may send a notification (e.g., an email, an SMS text message, etc.) to user device 260 indicating that the promotion is not available.

As shown by reference number 640, subscription API 618 may determine whether the billing information is valid (e.g., whether a form of payment, associated with the user, may permit the user to be billed for a product and/or service). If the billing information is not valid, subscription API 618 may notify exact target API 628 via a call. Exact target API 628 may send a notification (e.g., an email, an SMS text message, etc.) to user device 260 indicating that the billing information is not valid.

As shown by reference number 642, if the billing information is valid, subscription API 618 may call get pricing API 624 to request a price associated with the subscription. Get pricing API 624 may provide the price to subscription API 618. As shown by reference number 644, if subscription API 618 is unable to receive the price, subscription API 618 may notify exact target API 628 via a call. Exact target API 628 may send a notification (e.g., an email, an SMS text message, etc.) to user device 260 indicating that the subscription process has failed.

As shown by reference number 646, if the subscription process has not failed, subscription API 618 may call subscribe user API 626 to subscribe the user (e.g., to generate an account associated with the user). As shown by reference number 648, if subscribe user API 626 is unable to generate an account associated with the user, subscription API 618 may notify exact target API 628 via a call. Exact target API 628 may send a notification (e.g., an email, an SMS text message, etc.) to user device 260 indicating that the subscription process has failed. As shown by reference number 650, if subscribe user API 626 is able to generate the account associated with the user, subscription API 618 may notify exact target API 628 via a call. Exact target API may send a notification (e.g., an email, an SMS text message, etc.) to user device 260 indicating that the subscription process was successful. The message may include information that may permit the user to access the service, such as a login name, a temporary password, etc.).

As indicated above, FIGS. 6A-6B are provided merely as an example. Other examples are possible and may differ from what was described with regard to FIGS. 6A-6B.

Implementations described herein may allow a subscription device to generate an account, associated with a user, based on a minimal amount of user input, and may permit the subscription device to cause a kiosk device to provide a promotion to the user based on generating the account.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein. In some implementations, the user interfaces may be customizable by a device or a user. Additionally, or alternatively, the user interfaces may be pre-configured to a standard configuration, a specific configuration based on capabilities and/or specifications associated with a device on which the user interfaces are displayed, or a set of configurations based on capabilities and/or specifications associated with a device on which the user interfaces are displayed.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive customer information associated with a user at a kiosk device,
the customer information being received based on a user input to the kiosk device;
determine status information based on the customer information,
the status information including information that identifies whether the user is eligible for a promotion;
generate an account, associated with the user, based on the customer information and the status information;
provide the status information to the kiosk device to cause the kiosk device to at least one of:
provide the promotion; or
notify the user that the promotion is not available; and
provide a notification to the user based on the status information and based on the account.

2. The device of claim 1, where the one or more processors, when receiving the customer information, are further to:
receive the customer information based on an advertisement,
the advertisement including an offer for the promotion; and
where the one or more processors, when providing the status information, are further to:
provide the status information to cause the kiosk device to provide the promotion based on the advertisement.

3. The device of claim 1, where the one or more processors, when receiving the customer information, are further to:
receive the customer information based on a queue of customer information associated with a plurality of users,
the plurality of users being associated with a plurality of kiosk devices.

4. The device of claim 1, where the one or more processors, when receiving the customer information, are further to:
receive a payment identifier,
the payment identifier being associated with billing information associated with the user; and
where the one or more processors are further to:
provide the payment identifier to a billing device to cause the billing device to bill the user based on the billing information.

5. The device of claim 1, where the promotion includes a free DVD or CD rental;
where the one or more processors, when providing the status information, are further to:
provide the status information to cause the kiosk device to provide the free DVD or CD rental.

6. The device of claim 1, where the user input includes accessing the kiosk device.

7. The device of claim 1, where the user input includes swiping a payment card associated with the user;
where the one or more processors, when receiving the customer information, are further to:
determine the customer information based on information associated with the payment card.

8. A computer-readable medium storing instructions, the instructions comprising:
one or more instructions that, when executed by one or more processors, cause the one or more processors to:
receive customer information associated with a user at a kiosk device,
the customer information being received based on billing information provided to the kiosk device by the user;
determine status information based on the customer information,
the status information including information that identifies whether the user is eligible for a promotion;
generate an account, associated with the user, based on the customer information and the status information;
provide the status information to the kiosk device to cause the kiosk device to at least one of:
provide the promotion; or
notify the user that the promotion is not available; and
provide a notification to the user based on the status information and based on the account.

9. The computer-readable medium of claim 8, where the one or more instructions, that cause the one or more processors to receive the customer information, further cause the one or more processors to:
receive the customer information based on receiving a confirmation, via the kiosk device, that the customer information is correct,
the confirmation being received based on the customer information being displayed on a user interface associated with the kiosk device.

10. The computer-readable medium of claim 8, where the one or more instructions, that cause the one or more processors to receive the customer information, further cause the one or more processors to:
provide the billing information to a billing device, and
receive the customer information from the billing device.

11. The computer-readable medium of claim 8, where the one or more instructions, that cause the one or more processors to receive the customer information, further cause the one or more processors to:
receive the customer information based on determining that the billing information has been verified.

12. The computer-readable medium of claim 8, where the one or more instructions, that cause the one or more processors to determine the status information, further cause the one or more processors to:
determine that the user is eligible for the promotion based on determining that the user is a new user; and
where the one or more instructions, that cause the one or more processors to provide the status information to the kiosk device, further cause the one or more instructions to:
provide the status information to cause the kiosk device to provide the promotion based on determining that the user is a new user.

13. The computer-readable medium of claim 8, where the one or more instructions, that cause the one or more processors to generate the account, further cause the one or more processors to:
generate a username and password associated with the account; and
where the one or more instructions, that cause the one or more processors to provide the notification to the user, further cause the one or more instructions to:
provide the username and password.

14. The computer-readable medium of claim 8, where the one or more instructions, that cause the one or more processors to determine the status information, further cause the one or more processors to:
determine that the user is one of:
eligible for the promotion; or
ineligible for the promotion; and
where the one or more instructions, that cause the one or more processors to provide the notification to the user, further cause the one or more processors to:
provide the notification to indicate one of:
that the user is eligible for the promotion; or
that the user is ineligible for the promotion.

15. A method, comprising:
receiving, by a device, customer information associated with a user at a kiosk device,
the customer information being received based on a kiosk account associated with the user;
determining, by the device, status information based on the customer information,
the status information including information that identifies whether the user is eligible for a promotion;
generating, by the device, an account, associated with the user, based on the customer information and the status information;
providing, by the device, the status information to the kiosk device to cause the kiosk device to at least one of:
provide the promotion; or
notify the user that the promotion is not available; and
providing, by the device, a notification to the user based on the status information and based on the account.

16. The method of claim 15, where receiving the customer information further comprises:
receiving user preference information associated with the kiosk account; and
where generating the account further comprises:
generating the account based on the user preference information.

17. The method of claim 15, where generating the account further comprises:
receiving subscription pricing; and
generating the account based on the subscription pricing.

18. The method of claim 15, where the account is associated with a video or audio streaming service;
where providing the notification to the user further comprises:
providing information that permits the user to access the video or audio streaming service.

19. The method of claim 15, where determining the status information further comprises:
determining that the user is not eligible for the promotion based on at least one of:
determining that the user has already received the promotion;
determining that billing information associated with the user is invalid; or
determining that the user is already associated with an account; and
where providing the notification to the user further comprises:
providing a message indicating that the user is not eligible for the promotion.

20. The method of claim 15, where the account is associated with a video or audio streaming service;
where receiving the customer information associated further comprises:
determining that the user is associated with a user device;
where providing the notification to the user further comprises:
providing information that permits the user to download a video or audio streaming application to the user device.
